(19) United States
(12) Patent Application Publication
(10) Pub. No.: US 2007/0162403 A1
(43) Pub. Date: Jul. 12, 2007

(54) System and method for financing with a convertible repurchase agreement

(76) Inventors: James A. Rothschild, New York, NY (US); Jeffrey J. Zajkowski, Short Hills, NJ (US); Steve Wolf, Great Neck, NY (US); John J. Purcell, Darien, CT (US)

Correspondence Address: MILBANK, TWEED, HADLEY & MCCLOY, 1 CHASE MANHATTAN PLAZA, NEW YORK, NY, 10005-1413, US

(21) Appl. No.: 11/455,593

(22) Filed: Jun. 19, 2006

Related U.S. Application Data
(60) Provisional application No. 60/756,817, filed on Jan. 6, 2006.

(51) Int. Cl. G06Q 40/00

(52) U.S. Cl. 705/36 R

(57) ABSTRACT

A financial instrument comprises a condition wherein a first party agrees to deliver a number of first securities to a second party at a first time. The financial instrument further comprises a condition wherein the second party agrees to deliver a first amount to the first party at the first time. The financial instrument further comprises a condition wherein the first party agrees to repurchase the first securities from the second party at a second time. The financial instrument further comprises a conversion option, and a condition wherein the first party agrees to pay an option value at the second time, wherein the option value is an in-the-money value of the conversion option.

This application claims priority to U.S. Provisional Patent Application Ser. No. 60/756,817, entitled System And Method For Financing With A Convertible Repo, filed Jan. 6, 2006, the disclosure of which is incorporated herein by reference.

### BACKGROUND

There are a number of ways to raise financing for a company, such as by simple borrowing, issuing equity and issuing debt. The tax implications, rate of interest paid, and stock dilution are some of the considerations that might cause a company to select one financing method over another. Banks and others who provide financing to companies attempt to structure their products so that their products will satisfy as many of the client's considerations as possible.

Systems and methods are needed that provide financing to clients while satisfying client considerations with regard to interest rate paid, taxes and stock dilution.

The preceding description is not to be construed as an admission that any of the description is prior art relative to the present invention.

### SUMMARY OF THE INVENTION

In one aspect, the embodiments provide systems and methods for financing with a financial instrument. The financial instrument comprises a condition wherein a first party agrees to deliver a number of first securities to a second party at a first time. The financial instrument further comprises a condition wherein the second party agrees to deliver a first amount to the first party at the first time. The financial instrument further comprises a condition wherein the first party agrees to repurchase the first securities from the second party at a second time. The financial instrument further comprises a conversion option, and a condition wherein the first party agrees to pay an option value at the second time, wherein the option value is an in-the-money value of the conversion option.

In other aspects, the conversion option further comprises a strike price. In other aspects, the financial instrument further comprises a condition wherein the first party agrees to deliver the first amount to the second party as part of the repurchase of the securities at the second time. In other aspects, the financial instrument further comprises a condition wherein the first party agrees to make at least one interest payment to the second party. In other aspects, the at least one interest payment is made at the second time. In other aspects, the at least one interest payment comprises periodic interest payments that are made between the first time and the second time. In other aspects, the interest payment is below LIBOR. In other aspects, the financial instrument further comprises a condition allowing the seller to substitute second securities for the first securities between the first time and the second time. In other aspects, a value of the number of the first securities determined at the first time is substantially the same as the present value of the first amount and the periodic interest payments. In other aspects, a value of the number of the first securities determined at the first time is a fixed percentage greater than the first amount. In other aspects, the fixed percentage greater is approximately five percent greater. In other aspects, the financial instrument further comprises a condition wherein the first party agrees to periodically adjust the number of the first securities delivered to the second party based on a periodic determination of a market value of the first securities. In other aspects, the financial instrument further comprises a condition wherein the second party agrees to provide to the first party income derived from the first securities. In other aspects, the financial instrument further comprises a condition wherein the first party is prohibited from unwinding the financial instrument before the second time. In other aspects, the financial instrument further comprises a maturity date, wherein the second time is between the first time and the maturity date. In other aspects, the financial instrument further comprises a condition wherein the option value is net share settled in common stock of the first party. In other aspects, the financial instrument further comprises a condition wherein the option value is net cash settled. In other aspects, the financial instrument further comprises a condition allowing hedging of the conversion option in the public market. In other aspects, the second time is a put date. In other aspects, the second time is a call date. In other aspects, the second time is a maturity date. In other aspects, the second time is a fixed period of time after the first time. In other aspects, the first securities comprise common stock of the first party. In other aspects, the first securities comprise treasury securities.

In other aspects, the first securities comprise agency securities. In other aspects, the first securities comprise commercial paper. In other aspects, the first securities comprise mortgage-backed securities passthroughs. In other aspects, the first securities comprise collateralized mortgage obligations. In other aspects, the first securities comprise non-agency passthroughs. In other aspects, the conversion option is an option on common stock of the first party. The foregoing specific aspects are illustrative of those which can be achieved and are not intended to be exhaustive or limiting of the possible advantages that can be realized. Thus, the objects and advantages will be apparent from the description herein or can be learned from practicing the invention, both as embodied herein or as modified in view of any variations which may be apparent to those skilled in the art. Accordingly the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates an example system according to an embodiment;

FIG. 2 illustrates steps in a method according to an embodiment; and

FIG. 3 illustrates relationships between entities according to an embodiment.

It is understood that the drawings are for illustration only and are not limiting.

### DETAILED DESCRIPTION OF THE DRAWINGS

The various embodiments provide a financial instrument that includes features of a repurchase agreement and a conversion option. The combination of these features in a single instrument provides advantages that are not available with either a repurchase agreement or a conversion option. Before describing the combination and those advantages, it is helpful to understand repurchase agreements.

In a repurchase agreement, or repo, a seller transfers securities to a counter party/purchaser for some value, with a commitment from the seller to buy the securities back from the counter party at a future date on specified terms. There are at least two different types of repurchase agreements. One is an overnight repurchase agreement, and the other is a term repurchase agreement. In an overnight repurchase agreement, the seller generally has no rights to recall or substitute the securities but the repurchase agreement unwinds every night. In a term repurchase agreement, the seller generally does have a right to recall and substitute the securities but the repurchase agreement does not unwind until maturity. In a term repurchase agreement, because the seller has a right to recall and substitute the securities at its discretion, under GAAP and tax treatment, the seller is not treated as having sold the securities.

The repurchase agreement represents a collateralized loan to the seller, and the seller generally pays a rate of interest for the loan that is tied to an established index (e.g., LIBOR plus some percentage). There are a number of different securities that may be transferred and used in a repurchase agreement, such as: company common stock, treasury securities, money market instruments, federal agency securities, and mortgage-backed securities. When a seller uses a repurchase agreement in this way as a collateralized or secured loan, it is generally able to obtain better financing terms than it could get without the repurchase agreement. For example, if it can get financing at 7% without a repurchase agreement, it may be able to get financing at 6% by using a secured financing in a repurchase agreement.

In a repurchase agreement, the purchaser generally agrees to pay the seller any income that is derived from the securities while the purchaser is holding the securities.

### AN EXAMPLE SYSTEM

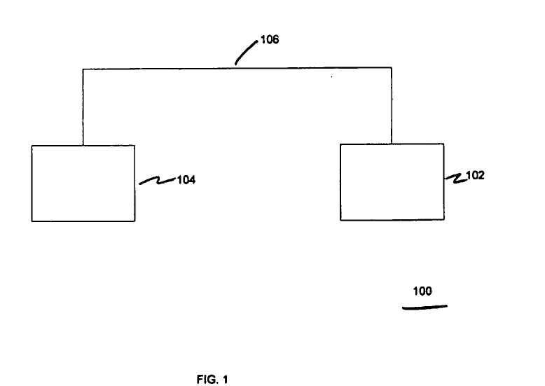

Referring to FIG. 1, an example system 100 according to an embodiment includes a client or seller 102 and a bank or counter party/purchaser 104. Seller 102 and counter party 104 are electronically interconnected by a network 106, that may be wired or wireless and may be an intra-net, extra-net, the Internet, or the PSTN, etc. Although not illustrated, seller 102 and counter party 104 include computer hardware, such as general purpose computers that include central processor units (CPUs), memory (RAM, ROM, EPROM, flash etc.), fixed and removable storage devices for computer executable software code and data storage (floppy drives, hard drives, CDs, DVDs, memory sticks, etc.), input and output devices (keyboards, pointing devices, monitors, displays, printers, etc.) and network interface devices (Ethernet, WiFi, modem, blue tooth, etc.). Software code to perform aspects of the invention can be sent over network 106 as an information signal and also stored at seller 102 and counter party 104.

### AN EXAMPLE METHOD

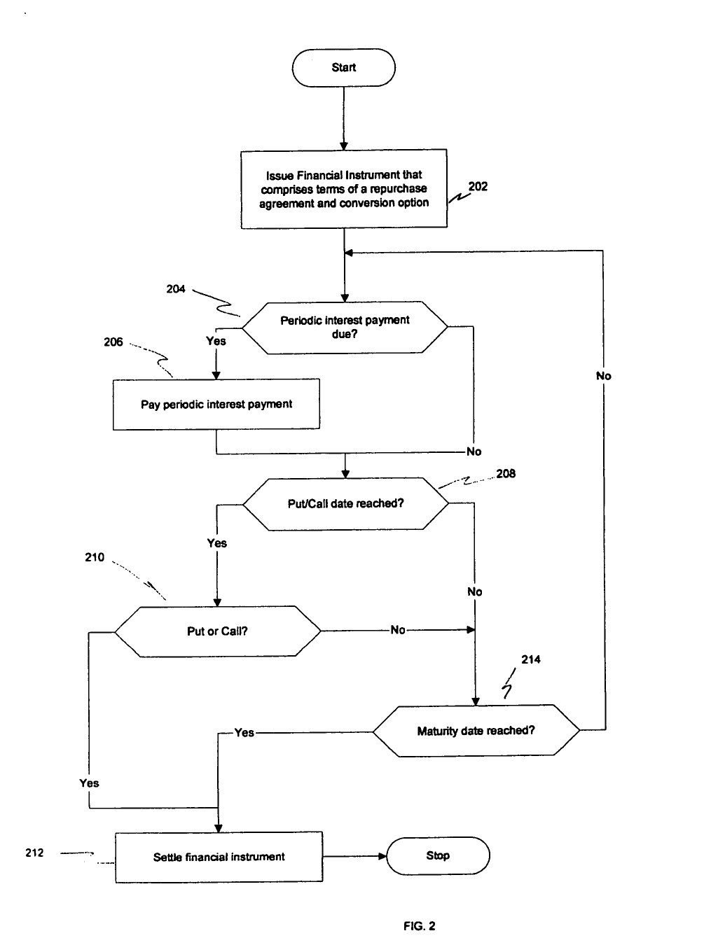

Referring to FIG. 2, a method according to one embodiment begins at step 202 with the issue of a financial instrument by counter party 104. The financial instrument has terms of a repurchase agreement and a conversion option.

Under the terms of the financial instrument, counter party 104 receives securities from seller 102 and provides funds to seller 102 in return. Seller 102 agrees to repurchase the securities from counter party 104 at a predetermined future date. Typically the repurchase price that seller 102 agrees to pay to counter party 104 at the future date is the same as the amount received at the beginning for sale of the securities. Counter party 104 also typically agrees to pay seller 102 any income derived from the securities. Seller 102 is also typically prohibited from unwinding the financial instrument prior to a put/call or maturity date. These terms are comparable to terms that may be found in a traditional repurchase agreement.

The financial instrument also has terms for a conversion option, and under those terms seller 102 agrees to pay counter party 102 at maturity, in either cash or shares, the value of an in-the-money amount of an equity call option on shares of seller 102's common stock.

The financial instrument has a maturity date, such as 10 years, and it may also have a put or call date such as 5 years. Under terms in one embodiment of the financial instrument, seller 102 agrees to make periodic interest payments to counter party 104. Because of the unique characteristics of the convertible repurchase agreement, the periodic interest payment is generally LIBOR minus a spread percentage.

At step 204, system 100 determines whether a periodic interest payment is due, and if so, seller 102 makes the periodic interest payment at step 206.

If the financial instrument has a put or call date, then at step 208, system 100 determines whether the put or call date has been reached, and if so, determines at step 210 whether the financial instrument has been put or called.

If the financial instrument has been put or called, then at step 212, system 100 settles the financial instrument.

If system 100 determines at step 208 that the put or call date has not been reached, or determines at step 210 that the financial instrument has not been put or called, then at step 214, system 100 determines whether the maturity date has been reached. If the maturity date has not been reached, then system 100 loops to step 204. If the maturity date has been reached, then at step 212, system 100 settles the financial instrument. One of the terms of the financial instrument requires seller 102 to pay at settlement the value, in either cash or shares, of an in-the-money value of an equity call option on common stock of seller 102 to counter party 104. Settlement of the principal and any coupons is typically in cash.

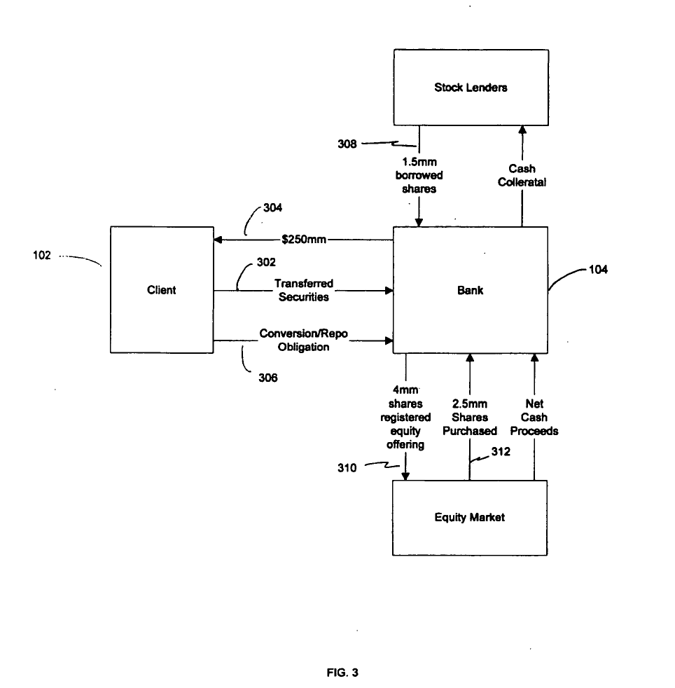

Referring to FIG. 3, an embodiment is illustrated with example terms. The example financial instrument has a five year maturity. Client or seller 102 initially transfers securities 302 to the bank or counter party 104, and seller 102 receives $250 mm 304 from bank or counter party/purchaser 104. Seller 102 also agrees to make periodic interest payments to counter party 104 that are LIBOR minus a spread. In the example the interest payments are payable quarterly at LIBOR−125 basis points.

With a $50 stock price, seller 102 also agrees 306 to pay at maturity to counter party 104 the in-the-money amount of an equity call option on 4 mm shares of seller 102's underlying stock. This is a conversion option.

The number of securities that seller 102 transfers to counter party 104 is a percentage of the fair value of the principal ($250 mm) and interest flows (LIBOR−125). In one example, the securities are 105% of that fair value. The conversion option 306 is not secured. Seller 102 may substitute the transferred securities 302 at any time with three business days notice. The transferred securities are marked to market each business day to maintain a margin at 105% of the fair value of the principal and interest flows.

Counter party 104 hedges the call option. Part of the hedge includes counter party 104 selling the maximum number of potential underlying shares (4 mm in the example) using a seller registration statement. The hedge includes counter party 104 borrowing 1.5 mm shares (308) and then selling 1.5 mm shares under seller 102's registration statement, as a fixed price offering. The hedge also includes counter party 104 making purchases from the equity market of an additional 2.5 mm shares at the market (312) and simultaneously selling 2.5 mm shares in the equity market under seller 102's registration statement. Some refer to this type of simultaneous purchase and sale as a double print.

Sale of the 1.5 mm shares and the 2.5 mm shares totals a 4 mm share sale (310) under seller 102's registration statement.

Some hypothetical examples help explain advantages of the embodiments. Without using a repurchase agreement, a seller might be able to get unsecured financing at 7%. Using a term repurchase agreement, which provides collateral, the same seller may be able get financing at 6%. The seller might also be able to get a yield advantage of 3% by issuing a convertible bond instead of a regular bond. By incorporating a term repurchase agreement with a conversion option, the seller may be able to get financing at 3%, which is a better rate than they could get with just a repurchase agreement or just a conversion option.

There are other advantages of the combination, which is treated as a secured financing with a lower interest expense. In particular the combination allows treasury stock method of accounting, so it is non-dilutive.

One of the reasons the combination is possible is the ability of purchaser 104 to do synthetic hedging. Seller 102 effectively issues a call option to counter party 104, and counter party 104 hedges the call option using a registration statement of seller 102. In the example, the hedge is a short position on 1.5 mm shares. However, under the applicable regulatory guidance, counter party 104 must issue under a registration statement the full number of shares that might be received (i.e., the full 4 mm shares). The structure that is illustrated in FIG. 3 allows counter party 104 to sell 4 mm shares under a registration statement and also finish with a 1.5 mm share short position.

In a term repo, the party selling the collateral or securities has the ability to substitute the securities, and because the seller can substitute the securities with three business days notice, the seller retains the securities on their accounting books.

In one embodiment, a value of the collateral (i.e., the transferred securities) is marked-to-market every day and the purchaser of the securities can price efficiently because they are fully secured. However, with respect to the conversion option, (the embedded call option) there is no collateral, and the value of the conversion option is not marked-to-market.

In contrast to a convertible bond, a convertible repurchase agreement is a non-distributed instrument.

If the common stock of seller 102 stock is down at maturity or at settlement, and the conversion option is out-of-the-money, then the financial instrument is treated like a term repurchase agreement. Seller 102 delivers the price they received at the beginning and receives back the securities that were transferred to the counter party/purchaser. However, if the stock is up at maturity, and the conversion option is in-the-money, then the seller pays any in-the-money amount of the conversion option at maturity in addition to the seller's delivery of the purchase price to the purchaser and receipt back of the securities.

If the repurchase agreement and the conversion option were separable obligations, they would be treated separately for accounting and tax. However, seller 102's obligation at maturity to repurchase the securities and also pay any in-the-money amount is a single obligation on the part of the seller. By treating the combination together, the seller gets the benefit of convertible bond accounting at the same time as a single counter-party transaction.

Structure of the conversion option as net share settled helps to minimize dilution, as illustrated using convertible bonds, which have features that are similar to a conversion option. Under net share settlement of a convertible bond, upon conversion the issuer delivers 1) cash equal to the lesser of $1,000 or conversion value, plus 2) if the conversion value is greater than $1,000, a number of shares whose value equals the difference between the conversion value and $1,000 (the “net share amount.”) This minimizes dilution because unlike a traditional convertible bond, where all the value is delivered in shares, a net share settled convertible bond only settles the value above $1,000 in shares. This also benefits earnings per share because only the number of shares that would be delivered upon conversion are included in the shares outstanding for earnings per share calculations.

A hypothetical example helps to illustrate. With an issue size of $250 mm, a stock price of $50.00, a conversion premium of 25%, and a strike rice of $62.50, the number of shares issued for a traditional convertible bond as compared to a net-share settled convertible bond are:

Total Shares Issued

| Stock Price | Traditional settlement | Net-share settlement |
|---|---|---|
| $55.00 | 0.0 mm | 0.0 mm |
| $60.00 | 0.0 mm | 0.0 mm |
| $65.00 | 4.0 mm | 0.153846 mm |
| $70.00 | 4.0 mm | 0.428571 mm |
| $75.00 | 4.0 mm | 0.666667 mm |
| $80.00 | 4.0 mm | 0.875000 mm |

Another advantage of the convertible repurchase agreement structure with contingent interest is incremental tax benefits. This allows higher tax deductions over the life of the transaction. A convertible repurchase agreement also includes a variable economic cost that is neither “remote” nor “incidential” and is payable if certain triggers are met. If the triggers are met, the security is then categorized as a contingent payment debt instrument (CPDI). This allows seller 102 to estimate and deduct the fair cost of the CPDI (typically a similar maturity non-convertible debt comparable yield). Excess deductions either become permanent or get recaptured based on final outcome.

Although illustrative embodiments have been described herein in detail, it should be noted and will be appreciated by those skilled in the art that numerous variations may be made within the scope of this invention without departing from the principle of this invention and without sacrificing its chief advantages.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. A financial instrument comprising:
a condition wherein a first party agrees to deliver a number of first securities to a second party at a first time;
a condition wherein the second party agrees to deliver a first amount to the first party at the first time;
a condition wherein the first party agrees to repurchase the first securities from the second party at a second time;
a conversion option; and
a condition wherein the first party agrees to pay an option value at the second time, wherein the option value is an in-the-money value of the conversion option.

2. A financial instrument according to claim 1, wherein the conversion option further comprises a strike price.

3. A financial instrument according to claim 1, further comprising a condition wherein the first party agrees to deliver the first amount to the second party as part of the repurchase of the securities at the second time.

4. A financial instrument according to claim 1, further comprising a condition wherein the first party agrees to make at least one interest payment to the second party.

5. A financial instrument according to claim 4, wherein the at least one interest payment is made at the second time.

6. A financial instrument according to claim 4, wherein the at least one interest payment comprises periodic interest payments that are made between the first time and the second time.

7. A financial instrument according to claim 4, wherein the interest payment is below LIBOR.

8. A financial instrument according to claim 1, further comprising a condition allowing the seller to substitute second securities for the first securities between the first time and the second time.

9. A financial instrument according to claim 1, wherein a value of the number of the first securities determined at the first time is substantially the same as a present value of the first amount plus interest.

10. A financial instrument according to claim 1, wherein a value of the number of the first securities determined at the first time is a fixed percentage greater than a present value of the first amount plus interest.

11. A financial instrument according to claim 10, wherein the fixed percentage greater is approximately five percent greater.

12. A financial instrument according to claim 1, further comprising a condition wherein the first party agrees to periodically adjust the number of the first securities delivered to the second party based on a periodic determination of a market value of the first securities.

13. A financial instrument according to claim 1, further comprising a condition wherein the second party agrees to provide to the first party income derived from the first securities.

14. A financial instrument according to claim 1, further comprising a condition wherein the first party is prohibited from unwinding the financial instrument before the second time.

15. A financial instrument according to claim 1, further comprising a maturity date, wherein the second time is between the first time and the maturity date.

16. A financial instrument according to claim 1, further comprising a condition wherein the option value is net share settled in common stock of the first party.

17. A financial instrument according to claim 1, further comprising a condition wherein the option value is net cash settled.

18. A financial instrument according to claim 1, further comprising a condition allowing hedging of the conversion option in the public market.

19. A financial instrument according to claim 1, wherein the second time is a put date.

20. A financial instrument according to claim 1, wherein the second time is a call date.

21. A financial instrument according to claim 1, wherein the second time is a maturity date.

22. A financial instrument according to claim 1, wherein the second time is a fixed period of time after the first time.

23. A financial instrument according to claim 1, wherein the first securities comprise common stock of the first party.

24. A financial instrument according to claim 1, wherein the first securities comprise treasury securities.

25. A financial instrument according to claim 1, wherein the first securities comprise agency securities.

26. A financial instrument according to claim 1, wherein the first securities comprise commercial paper.

27. A financial instrument according to claim 1, wherein the first securities comprise mortgage-backed securities passthroughs.

28. A financial instrument according to claim 1, wherein the first securities comprise collateralized mortgage obligations.

29. A financial instrument according to claim 1, wherein the first securities comprise non-agency passthroughs.

30. A financial instrument according to claim 1, wherein the conversion option is an option on common stock of the first party.

31. A method for financing, the method comprising:
receiving a number of first securities from a party at a first time;
delivering a first amount to the party at the first time;
receiving an agreement from the party to repurchase the first securities at a second time;
receiving a conversion option from the party; and
receiving an agreement from the party to pay an option value at the second time, wherein the option value is an in-the-money value of the conversion option.

32. A system for financing, comprising:
means for receiving a number of first securities from a party at a first time;
means for delivering a first amount to the party at the first time;
means for receiving an agreement from the party to repurchase the first securities at a second time;
means for receiving a conversion option from the party; and
means for receiving an agreement from the party to pay an option value at the second time, wherein the option value is an in-the-money value of the conversion option.

33. Computer executable software code transmitted as an information signal, the code for financing, the code comprising:
code to receive a number of first securities from a party at a first time;
code to deliver a first amount to the party at the first time;
code to receive an agreement from the party to repurchase the first securities at a second time;
code to receive a conversion option from the party; and
code to receive an agreement from the party to pay an option value at the second time, wherein the option value is an in-the-money value of the conversion option.

34. A computer-readable medium having computer executable software code stored thereon, the code for financing, the code comprising:
code to receive a number of first securities from a party at a first time;
code to deliver a first amount to the party at the first time;
code to receive an agreement from the party to repurchase the first securities at a second time;
code to receive a conversion option from the party; and
code to receive an agreement from the party to pay an option value at the second time, wherein the option value is an in-the-money value of the conversion option.

35. A programmed computer for financing, comprising:
a memory having at least one region for storing computer executable program code; and
a processor for executing the program code stored in the memory, wherein the program code comprises:
code to receive a number of first securities from a party at a first time;
code to deliver a first amount to the party at the first time;
code to receive an agreement from the party to repurchase the first securities at a second time;
code to receive a conversion option from the party; and
code to receive an agreement from the party to pay an option value at the second time, wherein the option value is an in-the-money value of the conversion option.
